(19) United States
(12) Patent Application Publication
(10) Pub. No.: US 2011/0056194 A1
(43) Pub. Date: Mar. 10, 2011

(54) HYDRAULIC SYSTEM FOR HEAVY EQUIPMENT

(75) Inventors: Mark Wojcicki, Waukesha, WI (US); Michael G. Onsager, Franklin, WI (US); Joseph Helfrich, Milwaukee, WI (US); Wayne G. Chmiel, Norway, WI (US); Peter Miller, Brookfield, WI (US)

(73) Assignee: Bucyrus International, Inc.

(21) Appl. No.: 12/938,897

(22) Filed: Nov. 3, 2010

Related U.S. Application Data
(63) Continuation-in-part of application No. 12/557,119, filed on Sep. 10, 2009.

(51) Int. Cl. F15B 11/17; F15B 21/02

(52) U.S. Cl. 60/428; 60/486

(57) ABSTRACT

Heavy equipment includes first and second hydraulic pumps, and first and second hydraulic actuators, where the first hydraulic actuator facilitates a first work function of the heavy equipment and the second hydraulic actuator facilitates a second work function of the heavy equipment. The heavy equipment further includes valving and a computerized controller. The valving is configured to allow the first hydraulic pump to be coupled to the first hydraulic actuator and the second hydraulic actuator, and to allow the second hydraulic pump to be coupled to the first hydraulic actuator and the second hydraulic actuator. The computerized controller is coupled to the valving, and has a logic module. The logic module provides instructions to the computerized controller to operate the valving as a function of inputs from an operator command, a sensor input, and prioritization logic associated with the first and second work functions, so as to optimize performance of the work functions facilitated by the hydraulic actuators with respect to available output of the hydraulic pumps.

### CROSS-REFERENCE TO RELATED PATENT APPLICATIONS

This application is a continuation-in-part of prior U.S. application Ser. No. 12/557,119, filed on Sep. 10, 2009, which is incorporated herein by reference in its entirety.

### BACKGROUND

The present disclosure relates generally to the field of hydraulic systems including hydraulic cylinders and motors. More specifically, the disclosure relates to the systems and methods used to control the workload of components in a hydraulic system so that hydraulic pumps and drive systems can be optimized for the total amount of flow available, and the desired work outcome. The technology disclosed is particularly useful in hydraulic systems for operation with heavy equipment, such as equipment used for mining and excavating.

### SUMMARY

One embodiment relates to heavy equipment. The heavy equipment includes first and second hydraulic pumps, and first and second hydraulic actuators, where the first hydraulic actuator facilitates a first work function of the heavy equipment and the second hydraulic actuator facilitates a second work function of the heavy equipment. The heavy equipment further includes valving and a computerized controller. The valving is configured to allow the first hydraulic pump to be coupled to the first hydraulic actuator and the second hydraulic actuator, and to allow the second hydraulic pump to be coupled to the first hydraulic actuator and the second hydraulic actuator. The computerized controller is coupled to the valving, and has a logic module. The logic module provides instructions to the computerized controller to operate the valving as a function of inputs from an operator command, a sensor input, and prioritization logic associated with the first and second work functions, so as to optimize performance of the work functions facilitated by the hydraulic actuators with respect to available output of the hydraulic pumps.

Another embodiment relates to a hydraulic system, which includes a plurality of hydraulic pumps, a plurality of hydraulic actuators, a manifold comprising a plurality of valves, and a computerized controller coupled to the manifold. The plurality of valves control a flow of hydraulic fluid from the plurality of hydraulic pumps to the plurality of hydraulic actuators, where the plurality of valves of the manifold are configured to allow each of the plurality of hydraulic pumps to be coupled to any one of the plurality of hydraulic actuators while not being coupled to the others of the plurality of hydraulic actuators. The computerized controller has a logic module that provides instructions to the computerized controller to operate the plurality of valves of the manifold to distribute hydraulic fluid flowing through the manifold among the plurality of actuators as a function of inputs from an operator command, a sensor input, and prioritization logic associated with work functions facilitated by the plurality of hydraulic actuators, so as to optimize performance of the work functions facilitated by the plurality of hydraulic actuators with respect to available output of the plurality of hydraulic pumps.

Yet another embodiment relates to heavy equipment. The heavy equipment includes a body, an articulated arm extending from the body, first and second actuators, a source of pressurized hydraulic fluid, a manifold, and a computerized controller. The first actuator facilitates a first work function of the heavy equipment, which includes raising and lowering the articulated arm. The second actuator facilitates a second work function of the heavy equipment, which includes moving the body of the heavy equipment. The manifold includes a plurality of valves for distributing to the first and second actuators hydraulic fluid received from the source of pressurized hydraulic fluid, and the computerized controller operates the manifold as a function of prioritization logic related to the first and second work functions. The prioritization logic is updated by the computerized controller during operation of the heavy equipment.

### BRIEF DESCRIPTION OF THE DRAWINGS

FIG. 1 is a side view of an excavator according to an exemplary embodiment.

FIG. 2 is a schematic diagram of the hydraulic system for the excavator of FIG. 1 which has a plurality of pumps driven by electric motors.

FIG. 3 is a flowchart of a software routine executed by a supervisory control in FIG. 2 to measure the wear of the motors and pumps in the hydraulic system.

FIG. 4 is a software routine executed by the supervisory controller to vary the assignment of the different pumps to the various hydraulic actuators.

FIGS. 5-6 are two tables depicting different assignments of the pumps to hydraulic functions of the excavator.

FIG. 7 is a perspective view of a power shovel according to an exemplary embodiment.

FIG. 8 is a plan view of the power shovel of FIG. 7.

FIG. 9 is a perspective view of a hydraulic system of the power shovel of FIG. 7.

FIG. 10 is a schematic diagram of a hydraulic system according to an exemplary embodiment.

FIG. 11 is a priority table for different work functions of an excavator according to an exemplary embodiment.

FIG. 12 is a flow chart of a logic module according to an exemplary embodiment.

### DETAILED DESCRIPTION

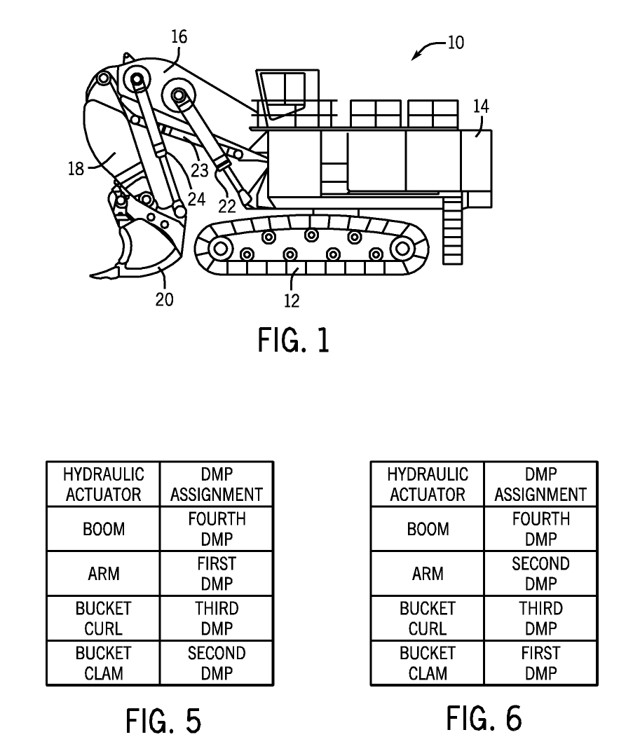

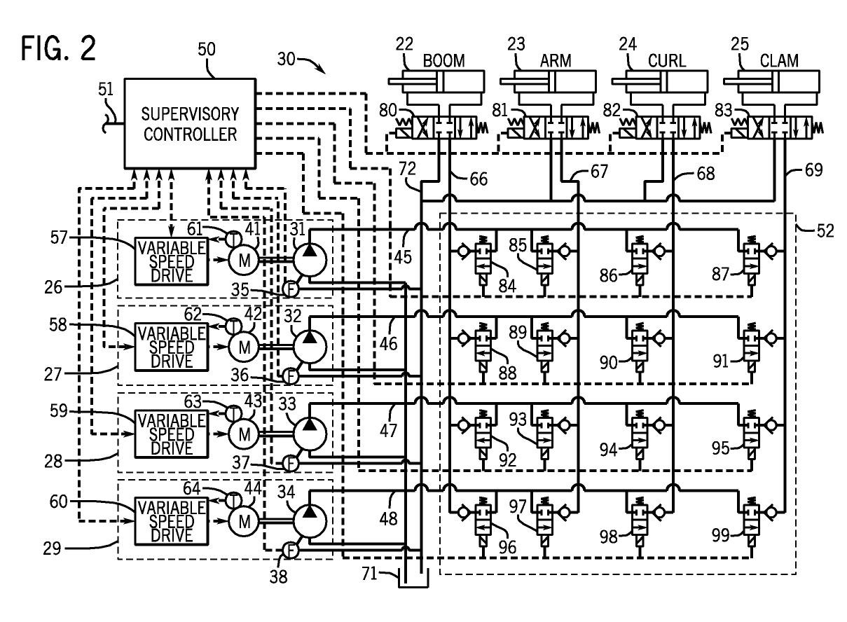

With initial reference to FIG. 1, an excavator, such as a front power shovel 10, has a crawler assembly 12 for moving the shovel across the ground. A cab 14 is pivotally mounted on the crawler tractor so as to swing in left and right. A boom 16 is pivotally mounted to the front of the cab 14 and can be raised and lowered by a boom hydraulic actuator 22 in the form of a first double-acting cylinder-piston assembly. An arm 18 is pivotally attached to the end of the boom 16 that is remote from the cab 14, and can be pivoted with respect to the boom by an arm hydraulic actuator 23 in the form of a second double-acting cylinder-piston assembly. At the remote end of the arm 18 from the boom is attached to a work tool (e.g., work implement), such as a bucket 20, that faces forward from the cab 14, hence this type of excavator is referred to as a front power shovel. The bucket 20 is pivoted or “curled” about the end of the arm 18 by a curl hydraulic actuator 24, in the form of a third double-acting cylinder-piston assembly. According to an exemplary embodiment, the bucket 20 is made up of two sections which can be opened and closed like a clam shell by a clam hydraulic actuator 25 (FIG. 2). The two bucket sections are held closed together during a digging work function and are separated in order to dump material into a truck or onto a pile.

With a reference to FIG. 2, the hydraulic system 30 for operating the power shovel comprises a set of four pumps 31, 32, 33, and 34 which draw fluid from a reservoir or tank 71. Each pump 31, 32, 33, and 34 has a supply outlet that is connected to a separate primary supply lines 45, 46, 47, and 48. The pressurized fluid from the supply outlet of the first pump 31 is fed into a first primary supply line 45, the second pump 32 feeds a second primary supply line 46, the third pump 33 feeds a third primary supply line 47, and the fourth pump 34 feeds a fourth primary supply line 48. The pumps 31-34 have fixed displacement so that the amount of fluid that is pumped is directly proportional to the speed at which the pump is driven (e.g., including piston or plunger pumping mechanisms, gear pumps, etc.). In other contemplated embodiments, one or more pumps (e.g., impeller or centrifugal pumps) may not be positive displacement pumps.

According to an exemplary embodiment, each of the four pumps 31, 32, 33, and 34 is driven by a separate electric motor 41, 42, 43 and 44, respectively. Each motor 41, 42, 43 and 44 is operated by a variable speed drive 57, 58, 59, and 60 which vary the frequency of the alternating current applied to the respective motor in order to operate the motor at a desired speed. Any of several well known variable speed drives can be utilized, such as the one described in U.S. Pat. No. 4,263,535, which description is incorporated herein by reference. Each combination of a pump, motor and variable speed drive forms a drive-motor-pump assembly (DMP) 26, 27, 28, and 29. It should be understood that a hydraulic system according to other embodiments may have a greater or lesser number of DMP's. Although referred to as a DMP, in contemplated embodiments a motor (e.g., via gearing) or a drive may be coupled to two or more separate pumping mechanisms, or one or more of the motors may be an engine, where the drive is a throttle and a transmission or clutch may be used to control the interaction between the engine and the pumping mechanism.

Each pump 31-34 has a case drain through which fluid leakage flows from the pump to the reservoir 71. Each of those case drains is coupled to a reservoir return line 72 by a separate flow meter 35, 36, 37 and 38 connected to the respective variable speed drive 57, 58, 59, and 60, directly or indirectly, such as by way of a supervisory controller 50. A separate temperature sensor 61, 62, 63 and 64 is mounted on each of the motors 41, 42, 43, and 44 respectively, to sense the temperature and provide a signal back to the associated variable speed drive 57, 58, 59, and 60. Thus in addition to controlling the speed of the associated motor, each variable speed drive also gathers data about the motor temperature and the pump drain flow.

The DMP's 26, 27, 28, and 29, specifically the variable speed drives 57, 58, 59, and 60, are controlled by the supervisory controller 50 which in some embodiments is a microcomputer based device that responds to control signals from the human operator of the power shovel and other signals to control the hydraulic actuators 22, 23, 24, and 25 to operate the shovel as desired. Those signals are received by the supervisory controller 50 over a control network 51. The supervisory controller responds to those signals by determining the amount of hydraulic fluid necessary to be produced by each pump 31, 32, 33, and 34 and accordingly controls the motor 41, 42, 43, and 44 that drives the respective pump.

The four primary supply lines 45, 46, 47, and 48 feed into a distribution manifold 52 which selectively directs the fluid flow from each pump to different ones of the four hydraulic actuators 22, 23, 24, and 25. Specifically, the manifold 52 has a first actuator supply line 66 which feeds a solenoid operated first control valve 80 for the boom hydraulic actuator 22. The first control valve 80 is a three-position, four-way valve, which directs fluid from the first actuator supply line 66 to one of the chambers of the cylinder of the boom hydraulic actuator 22, and drains fluid from the other cylinder chamber into the reservoir return line 72 that leads to the reservoir 71. In other embodiments, other directional control valves may be used. Depending upon the position of the first control valve 80, the first hydraulic actuator 22 is driven in either of two directions to thereby raise or lower the boom 16. Similarly, the second, third, and fourth actuator supply lines 67, 68, and 69 from the distribution manifold 52 are connected by similar second, third, and fourth control valves 81, 82, and 83 to the arm hydraulic actuator 23, the curl hydraulic actuator 24, and the clam hydraulic actuator 25, respectively. The four actuator control valves 80-83 are independently operated by separate signals from the supervisory controller 50. Although the present hydraulic system 30 utilizes control valves 80-83 between the distribution manifold 52 and the hydraulic actuators 22-25, the control valves could be eliminated by incorporating their functionality into additional valves in the distribution manifold to control flow to and from each cylinder chamber.

The present distribution manifold 52 has a matrix of sixteen distribution valves 84-99. Each distribution valve couples one of the primary supply lines 45, 46, 47, or 48 to one of the actuator supply lines 66, 67, 68, or 69. Therefore, when a given distribution valve 84-99 is electrically operated by a signal from the supervisory controller 50, a path is opened between the associated primary supply line and actuator supply line, thereby applying pressurized fluid from the pump connected to that primary supply line to the control valve 80, 81, 82, or 83 connected to that actuator supply line. For example, when distribution valve 85 is activated, fluid from the first pump 31 flows through the first primary supply line 45 into the second actuator supply line 67 and onward to the second control valve 81. By selectively operating one or more of the distribution valve 84-99, the output from each pump 31-34 can be used to operate each of the four hydraulic actuators 22, 23, 24, or 25. This results is a given pump being assigned to a hydraulic actuator. It should be understood that on a particular power shovel, there may be a greater or lesser number of pumps and a greater or lesser number of hydraulic actuators; in which case the distribution manifold 52 will be configured with a corresponding different number of distribution valves. For example, hydraulic motors may independently drive the left and right tracks of the crawler assembly 12 to propel the power shovel.

It also should be understood that the output from two or more pumps can be combined to supply the same hydraulic actuator 22-25. For example, if only the arm hydraulic actuator 23 is active, the output from multiple pumps can be combined so that the arm is driven to dig into the earth with maximum speed and force. When another shovel function is to operate simultaneously with the arm, one or more of the pumps previously connected to the arm function is reassigned to provide fluid so that the other shovel function is to operate simultaneously with the arm. One or more of the pumps previously connected to the arm function is reassigned to provide fluid to the other shovel function, by redirecting the flow through the distribution manifold 52. Also should DMP 26-29 fail, it is deactivated by shutting off the associated variable speed drive and disconnecting the associated pump by closing all the valves in the distribution manifold 52 that are connected to the respective primary supply line. In this case, fluid from the remaining pumps supplied through the distribution manifold to operate the hydraulic actuators. If, however, the output of a particular pump is not required at a given point in time, its variable speed drive is deactivated so that the motor and thus that pump do not operate.

For very large power shovels, relatively large forces are encountered by the arm hydraulic actuator 23 and curl hydraulic actuator 24 during a digging operation. In addition, the arm and curl hydraulic actuators 23 and 24 tend to be operated for longer periods of time then that of the other hydraulic actuators. The clam hydraulic actuator 25 associated with the bucket 20 typically is significantly smaller and consumes far less hydraulic fluid. In previous power shovels, a given pump often was dedicated to supplying fluid to one of the hydraulic actuators and thus the different motor-pump combinations performed different levels of work. In other words, because the pumps and motors for the arm and the bucket curl functions perform considerably more work than other pumps and motors in the hydraulic system, those heavily worked components tended to require more maintenance and more frequent replacement than the other motors and pumps. Therefore, the different motor/pump combinations required servicing at different times during which the entire power shovel had to be taken out of service. The resultant downtime adversely affected the power shovel's overall productivity and economy of operation.

Embodiments disclosed herein overcome the problems with such previous systems by dramatically changing the assignment of the DMP's to the hydraulic actuators so that each motor/pump combination is exposed to substantially the same amount of use and work. As a consequence, all the DMP's will require maintenance and possible replacement at about the same point in time. Thus, the service and replacement intervals for the DMP's are synchronized so that the maintenance intervals, mean time to repair, and mean time between failure are optimized and provide a longer mean time between failure for the entire hydraulic system. This reduces the number of service down periods over the life of the excavator and thereby increases productivity.

In order to determine the usage of the DMP's, the supervisory controller 50 gathers data regarding the operation of their motors and pumps, such as electric current and voltage applied to the motor, motor temperature, speed, torque, aggregate operating time, and amount of pump drain flow. The accumulated data is utilized to determine the relative amount of work performed by each DMP 26, 27, 28, and 29. To this end the supervisory controller 50 executes different software routines that gather and analyze the pump and motor data to estimate the remaining anticipated life of those components and the aggregate amount of use that they have provided. The term DMP is being used to refer to performance of the motor/pump combination as well as performance of the individual motor and pump therein.

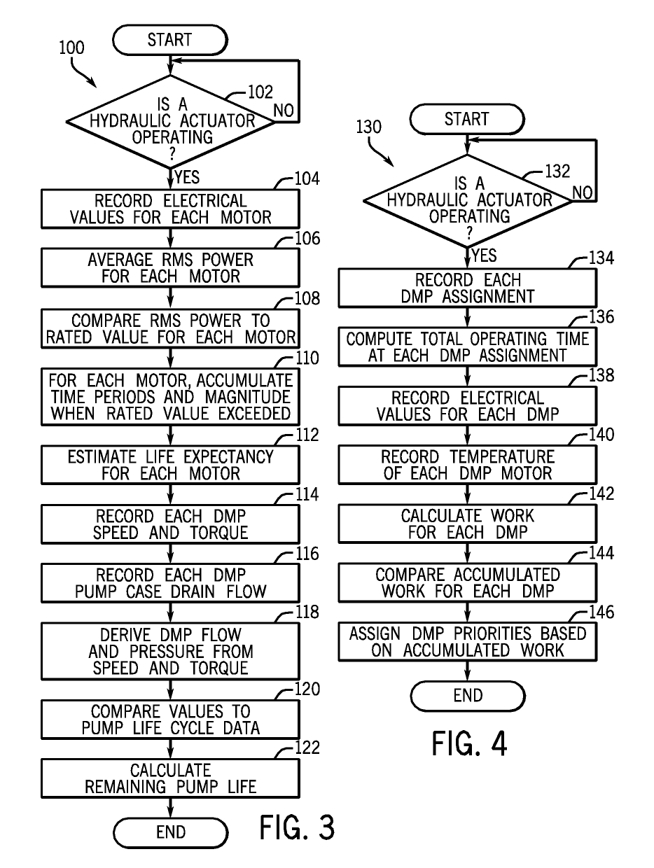

With reference to FIG. 3, a DMP life routine 100 is executed periodically on a timed-interrupt basis by the supervisory controller 50. This software routine commences at step 102 where a finding is made whether at least one actuator 22-25 of the power shovel 10 is currently being operated. The execution of the routine loops through this step until one of the hydraulic actuators 22-25 begins operating, at which time the process advances to step 104. At this juncture, the supervisory controller 50 obtains data indicating the magnitudes of the electric current and voltage that each variable speed drive 57-60 is applying to is associated motor 41-44. Each variable speed drive contains circuitry for measuring the magnitude of the voltage and current and converting those measurements into digital data for transmission to the supervisory controller 50. Next, the recorded electrical data are used at step 106 to compute the average RMS power consumed by each motor during a predefined measurement time period. At step 108, the newly computed RMS power values are compared to the rated value for each respective motor, as specified by the motor manufacturer to determine whether the operation exceeds the rated power for that motor. If so, for each motor the magnitudes that its rated power value is exceeded are integrated at step 110 to derive a value indicative of the aggregate excessive use of the motor. Those excessive use values then are used at step 112 to calculate the life expectancy of each motor 41-44. For example, the greater the amount of time that the rated power is exceeded and the aggregate magnitude of that excess decreases the life of the motor from the nominal life expectancy specified by the motor manufacturer. The nominal life expectancy is based on the rated power level not being exceeded. An empirically derived relationship for the particular type of motor is used to calculate a how much the motor life expectancy has decreased due to the actual duration of excessive power operation and the aggregate magnitude of that excessive power. The duration of excessive power operation is based on the sampling period for the motor electrical values. The decrease in the expected motor life and the nominal life expectancy are used to project a life expectancy for each motor 41-43. That information is then stored in a table within the supervisory controller 50.

Thereafter at step 114, the DMP life routine 100 enters a section at step 116 in which the present life expectancy of each pump 31-34 is estimated. The supervisory controller 50 initially records the speed and torque of the motors 41-43, which information is derived from the electric voltage and current levels applied by the variable speed drives 57-60. Alternatively, the speed and torque data can be measured by sensors attached to the drive shaft linking a motor to a pump. The supervisory controller 50 also obtains the amounts of fluid flow exhausting from the pump case drains. Those flow rates are sensed by the flow meters 35, 36, 37, and 38 connected to circuitry in the variable speed drives 57, 58, 59, and 60 which relay the case drain flow data to the supervisory controller 50. In other embodiments, the flow meters 35, 36, 37, and 38 are coupled directly to (e.g., wired to) the supervisory controller 50. Then at step 118, the amounts of fluid flow and pressure at the supply outlet of each pump 31-34 are derived from the respective speed and torque values. Specifically, the flow is the product of the speed and the fixed pump displacement. The torque correlates directly with the pump supply outlet pressure. Alternatively the fluid flow and pressure can be measured directly by sensors at the supply outlet of each pump 31-34.

At step 120, the values for the amounts of supply outlet fluid flow, pump pressure, and the case drain flow are compared with data provided by the manufacturer of the pumps to determine the present point on the life cycle for each pump. Specifically, the leakage of the pump represented by the flow from the pump case drain increases as a pump ages. In other words, the older the pump, the greater the case drain flow, however, the actual case drain flow at any point in time also is a function of the fluid flow and pressure produced at the supply outlet by the pump. That is, the case drain flow increases as the flow and pressure produced by the pump increase. A typical pump manufacturer has correlated the expected pump case drain flow for various pressure and flow amounts at different times during the life cycle of the pump. By comparing the actual fluid flow, pressure and pump case drain flow to manufacturer specification data, the supervisory controller 50 is able to determine the remaining life of each of the pumps 31-34, at step 122. This determination is stored with the memory of the supervisory controller 50 for display to the pump operator and service personnel, as well as for determining the trends of the pump life cycle to estimate when pump maintenance and replacement will be required.

In contemplated embodiments, the determination of remaining life is used as a weight or factor by the supervisory controller when determining the order of pumps to use. As such, a first pump determined to have low remaining life may be passed over for a second pump determined to have greater remaining life despite the second pump having performed a greater cumulative amount of work. In some contemplated embodiments, the cumulative amount of work of each pump is scaled by a factor associated with the life determination, while in other embodiments the cumulative amount of work is offset by an amount associated with the life determination.

With reference to FIG. 4, the supervisory controller 50 also executes a software DMP assignment routine 130, that allocates the output of each pump 31-34 to one of the hydraulic actuators 22-25 based on the accumulated amount of use of each DMP 26-29. As noted previously, the arm and bucket curl hydraulic actuators 23 and 24 operate more frequently and demand a greater amount of force from the hydraulic system than the boom and bucket clam hydraulic actuators 24 and 25. Therefore, the DMP's that supply fluid to the arm and bucket curl hydraulic work more intensely than other DMP's. The DMP assignment routine 130 determines the aggregate amount of work that each motor/pump combination has performed and adjusts the assignment of the DMP's 26-29 to the various hydraulic actuators 22-25 to approximately equalize the work being performed. This results in all the motor/pump combinations incurring essentially the same amount of wear so that they should require maintenance and ultimately replacement at the approximately same time.

The DMP assignment routine 130 commences at step 132 where a finding is made whether the hydraulic system 30 is currently operating at least one actuator, if so, the routine advances to step 134. At that point, the present assignments of the four DMP's 26, 27, 28 and 29 to the different hydraulic actuators 22, 23, 24, and 25 is recorded as a table in the memory of the supervisory controller 50. FIG. 5 depicts an exemplary table in which for each hydraulic function one of the DMP's is designated. That table also is used by the supervisory controller 50 in opening and closing the distribution valve 84-99 in the distribution manifold 52 to direct fluid from each pump to the designated hydraulic actuator. The exemplary table, the supervisory controller 50 would open distribution valve 96 to direct the fluid from the fourth pump 34 to the boom supply line 66, and open distribution valve 85 to direct the fluid from the first pump 31 to the arm supply line 67. Similarly distribution valve 94 is opened to direct the fluid from the third pump 33 to the curl supply line 68 and distribution valve 91 is opened to direct the fluid from the second pump 32 to the clam supply line 69.

Returning to the DMP assignment routine 130 in FIG. 4, the total amount of time that each DMP 26-29 has operated when assigned to each hydraulic actuator is determined at step 136. For each DMP, the supervisory controller 50 implements a separate timer in software that runs whenever the respective DMP is operating. This provides a cumulative record of the total time that each motor 41-44 and each pump 31-34 has operated.

At step 138 the magnitudes of electric voltage and current that the respective variable speed drive 57, 58, 59, and 60 applies to the associated motor 41, 42, 43 and 44 are read by the supervisory controller 50. Each variable speed drive 57, 58, 59, and 60 stores a digitized temperature value resulting from a signal produced by the temperature sensor 61, 62, 63 or 64 attached to the associated motor 41, 42, 43, or 44, respectively. The temperature values also are read from the variable speed drives and stored within the memory of the supervisory controller 50 at step 140.

At step 142, the electrical values read for each motor 41-44 are used to determine the amount of work that the respective DMP performed. Specifically, the current and voltage levels for a particular motor are multiplied to produce a value denoting the amount of electrical power consumed during the time interval between measurements. Not all consumed input electrical power is converted into mechanical power for driving the pump, because energy is lost as heat produced in the motor. The measured temperature of the respective motor is used to calculate the amount of the electrical power that was consumed in heating that motor, i.e., the heat power loss. Therefore, the mechanical power provided by the associated pump 31-34 is calculated by subtracting the heat power loss from the amount of electrical power consumed. The resultant mechanical power value then is integrated over the measurement interval to derive the amount of work that the pump performed. The new amount of work then is added to a sum of similar amount of work calculated previously to provide a measurement of the aggregate amount of work that the pump has performed since its installation. This work computation is performed individually for each of the pumps 31-34 and the resultant aggregate amounts of work are stored in the supervisory controller 50. At step 144, the DMP's 26-29 are ranked in order of the aggregate amount of work that each has performed.

As noted previously, the DMP's supplying the arm and curl hydraulic actuators 23 and 24 perform a greater amount of work over time than the boom and clam hydraulic actuators 22 and 25. Thus the DMP's that control the flow of fluid to the arm and curl hydraulic actuators correspondingly perform a greater amount of work. The purpose of the DMP assignment routine 130 is to equalize the aggregate amounts of work that the motor/pump combinations perform so that they are subjected to substantially equal amount of wear and therefore require maintenance and ultimately replacement at approximately the same time. Doing so reduces how often the power shovel 10 must be taken out of operation.

In a standard configuration of the distribution manifold 52, a separate pump 31-34 is connected to feed fluid to a different hydraulic actuator 22-25. Which pump is connected to which hydraulic actuator is determined dynamically in response to the ranking of the DMP's based on the aggregate amount of work that each performed. The DMP-to-hydraulic-actuator assignments are recorded as a table in the memory of the supervisory controller 50 and FIG. 5 depicts as exemplary set of those assignments. Therefore at step 146, the DMP work rankings are inspected to ensure that the DMP's with the least aggregate amounts of work are assigned to the arm and curl hydraulic actuators 23 and 24. Assume for example that upon entering step 146, the DMP to hydraulic actuator assignments are as depicted in FIG. 5, the second DMP 27 now has the greatest aggregate amount of work, and the fourth DMP 29 has the least aggregate amount of work. The supervisory controller 50 in this case will reassign the second DMP 27 to the bucket claim hydraulic actuator 25, the fourth DMP 29 to the arm hydraulic actuator 25 as depicted in FIG. 6. The rearrangement of the DMP to hydraulic actuator assignments causes the supervisory controller 50 to change the configuration of open and closed distribution valves 86-97 connected to the pumps 31-34 in each DMP to the hydraulic actuator 22-25 designated in the assignment table.

For machines in which the different hydraulic actuators are subjected to substantially equal forces, the assignment of DMP's can be based on operating time. For example, the DMP that with the lowest aggregate amount of work is assigned to the hydraulic actuator that operates most often. Similarly the DMP that with the greatest aggregate amount of work is assigned to the hydraulic actuator that operates least often. In another variation of the present control technique, when a single hydraulic actuator is operating, the inactive DMP with the lowest aggregate amount of work is assigned to provide fluid that actuator.

In another situation, a given hydraulic actuator may have a varying demand for hydraulic fluid depending on the force acting on that actuator. One DMP alone may not be able to meet all demand levels. Therefore at higher demand levels, multiple pumps are used to provide fluid to that given hydraulic actuator. Here the DMP's are assigned to the given hydraulic actuator in order from the DMP with the lowest aggregate amount of work to the DMP with the greatest aggregate amount of work. Thereafter, when the demand for hydraulic fluid from a hydraulic actuator decreases, the DMP's are unassigned in the reverse order. Specifically, the DMP with the greatest aggregate amount of work is disconnected first and the DMP with the lowest aggregate amount of work remains connected until fluid no longer is needed.

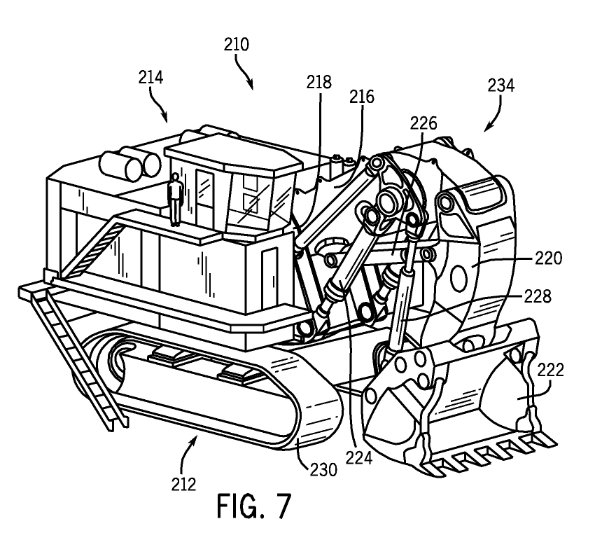

Referring to FIG. 7, an excavator, such as a power shovel 210, has a crawler truck 212 (e.g., transportation system) upon which is mounted a cab 214 (e.g., body) of the power shovel 210. The power shovel 210 further includes an articulated arm 234, which includes a boom 216 that connects to the cab 214 by a pivot joint 218, which enables the boom 216 to move up and down. The boom 216 has a remote end to which an arm 220 is pivotally connected. The arm 220, in turn, has a remote end to which a work implement, such as a bucket 222, is pivotally attached. In some embodiments, the bucket 222 may be a clam-type bucket having two pieces that open and close, somewhat like a clam shell (not shown). In other embodiments, another form of work implement (e.g., fork, breaker, wrecking ball) is attached to the articulated arm 234. Although shown as the power shovel 210 in FIG. 7, heavy equipment and hydraulic systems disclosed herein are not limited to power shovels unless expressly recited in the claims. In contemplated embodiments, the disclosure provided herein may be used with a backhoe, a loader bucket, a skid loader, a crane, a drilling rig, or other forms of mobile or immobile heavy equipment and hydraulic systems.

During operation of the power shovel 210, the boom 216, the arm 220, and the bucket 222 are moved with respect to each other by separate hydraulic actuators 224, 226, 228 in the form of cylinder and piston assemblies (i.e., hydraulic cylinders). As such, the hydraulic actuators 224, 226, 228 facilitate lifting, lowering, crowding, digging, crushing, maneuvering, and other work functions associated with the articulated arm 234 and a work implement associated with the articulated arm 234, such as the bucket 222 of the power shovel 210. The crawler truck 212 is moved on tracks 230 driven by actuators in the form of hydraulic or electric motors, which facilitates locomotion of the power shovel 210 (e.g., propel work function, turn work function). Additionally the cab 214 is rotated about the tracks 230 by way of actuators 236 (e.g., slew motors), which may be hydraulic or electric motors, facilitating work functions requiring rotational movement of the power shovel 210.

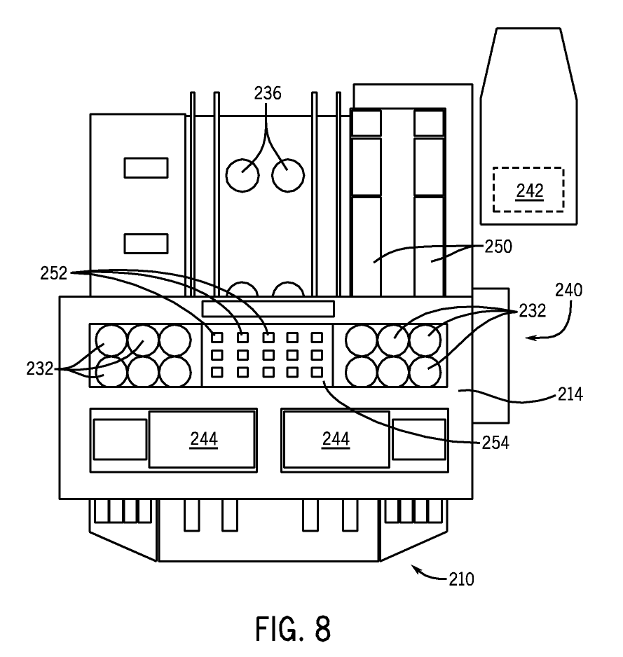

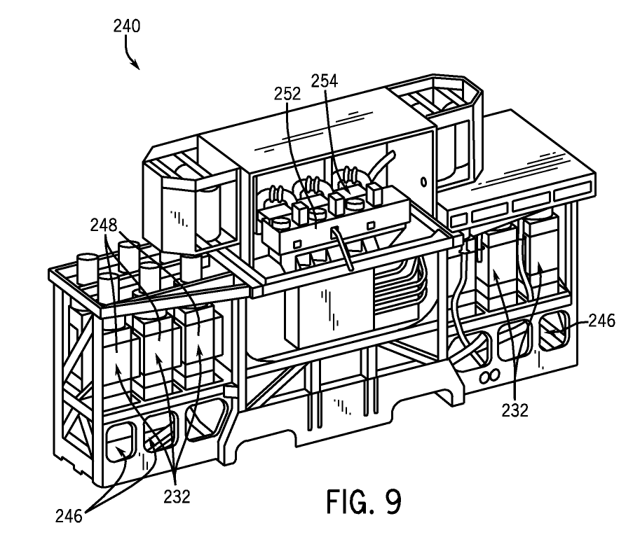

Referring to FIGS. 7-9, the power shovel 210 includes a powerhouse (e.g., power source, generator) supplying electricity to a hydraulic system 240 (FIGS. 8-9). A computerized controller 242 supervises communication of electricity from electric generators 244 of the powerhouse to one or more hydraulic pumps 232 of the hydraulic system 240. According to an exemplary embodiment, the hydraulic pumps 232 can be selectively activated based on the demand for hydraulic fluid by actuators of the power shovel 210, such as actuators 224, 226, 228 (FIG. 7) and 236 (FIG. 8).

According to an exemplary embodiment, each hydraulic pump 232 includes a pumping mechanism 246 (FIG. 9) (e.g., pistons, impeller), a motor 248 (FIG. 9) (e.g., electric motor, engine), and a drive 250 (FIG. 8) (e.g., inverter, clutch) to control interaction between the motor 248 and the pumping mechanism 246 of the hydraulic pump 232. In some embodiments, the power shovel 210 includes more than one hydraulic pump 232, including corresponding motors 248, drives 250, and pumping mechanisms 246. The hydraulic pumps 232 of the power shovel 210 may have the same or different capacities relative to each other. During operation of the power shovel 210, the computerized controller 242 operates the hydraulic pumps 232 via the drive 250 of each pump 232, in some embodiments. The hydraulic pumps 232 may be controlled independently of each other, allowing different pumps 232 to be run at different speeds. In contemplated embodiments, a pumping mechanism (e.g., piston set) may be driven by more than one motor, or a single motor may drive more than one pumping mechanism. In other contemplated embodiments, a drive may be used to control more than one motor associated with one or more pumping mechanisms. In still other contemplated embodiments different forms of motors may be used, such as engines, to drive one or more pumping mechanisms.

In some embodiments, the computerized controller 242 operates the pumps 232 according to techniques described with regard to FIGS. 3-4, such as based upon an estimate of the cumulative work performed by each hydraulic pump 232. In other embodiments, the computerized controller 242 activates and deactivates the hydraulic pumps 232 in a fixed order, regardless of cumulative work performed. In still other contemplated embodiments, the computerized controller 242 activates and deactivates the hydraulic pumps 232 in a random order so that, over time, work performed by the hydraulic pumps 232 will be approximately equal. Random selection may be facilitated by a random number generator, and the selection of hydraulic pumps 232 may be weighted to favor hydraulic pumps 232 that are in better working condition, such as those determined to have greater remaining life or those determined to have performed less cumulative work. In still other embodiments, the hydraulic pumps 232 are operated according to still other systems.

From the hydraulic pumps 232, hydraulic fluid is delivered through plumbing (e.g., a hydraulic circuit) to valving 252 for distributing the hydraulic fluid to hydraulic actuators of the power shovel 210, such as actuators 224, 226, 228 (FIG. 7) and 236 (FIG. 8). According to an exemplary embodiment, the valving 252 is configured to couple at least two of the pumps 232, to either of at least two different hydraulic actuators. In some embodiments, the valving 252 is configured to allow each pump 232 in a set of two or more pumps 232 to be coupled to each hydraulic actuator in a set of two or more hydraulic actuators. In some embodiments, the valving 252 allows two or more of the pumps 232 to be coupled to the same hydraulic actuator at the same time. In other contemplated embodiments, a pump 232 may be coupled to two or more hydraulic actuators at the same time, where adjustable restrictors or pressure-control valves provide hydraulic fluid from the same pump 232 to two or more actuators at different pressures.

According to an exemplary embodiment, the valving 252 is located in or associated with a manifold 254 (e.g., common manifold, central distributor, distribution hub). As such, plumbing from the hydraulic pumps 232 delivers hydraulic fluid to the manifold 254, which then allocates the hydraulic fluid, via the valving 252, to particular actuators to perform particular work functions of the power shovel 210. In some embodiments, the valving 252 of the manifold includes a matrix of solenoid valves, where a single solenoid valve is associated with a coupling between each hydraulic pump 232 in the set of pumps with each actuator in the set of actuators. Operation of valving 252 in the manifold 254 allows flows from different hydraulic pumps 232 to be combined for different work functions at different times in a dig cycle of the excavator.

According to an exemplary embodiment, the net hydraulic flow available from the hydraulic pumps 232 is less than the net hydraulic flow demanded to perform all work functions of hydraulic actuators of the power shovel 210. Combining the flows and pressures of the different hydraulic pumps 232 at different times during the dig cycle allows for optimal or increased-efficiency with the selection of hydraulic pumps 232 for the design and manufacturing of the power shovel 210. The pumps 232 need not be selected based upon a maximum pumping requirement for each work function of the power shovel 210. Instead, in some such embodiments pumps 232 may be combined to meet the maximum pumping requirements. Additionally, operation of the manifold 254 allows the computerized controller 242 to combine and use hydraulic pumps 232 so as to equalized utilization of the pumps 232, to avoid excessive wear on particular pumps 232 and to reduce the associated maintenance and downtime required to fix or replace the pumps 232.

According to an exemplary embodiment, the valving 252 is controlled by a computerized controller 242. To facilitate a particular work function of the power shovel 210, the computerized controller 242 operates the valving 252 to supply hydraulic fluid to one or more actuators associated with the work function. By way of example, for a work function involving lifting of the bucket, the computerized controller 242 may operate a valve configured to allow delivery of hydraulic fluid from one or more of the pumps 232 to the hydraulic actuators 224, 226, 228 (FIG. 7) associated with the articulated arm 234. For other work functions involving locomotion of the power shovel 210, the computerized controller 242 may redirect hydraulic fluid from one or more of the same pumps 232 to actuators associated with rotation of the tracks 230. In some embodiments, the computerized controller 242 further controls the speed of the pumps 232 and the rate of power production from the powerhouse. In some embodiments, the computerized controller 242 includes one or more sub-controllers, which may be in direct or indirect communication with each other.

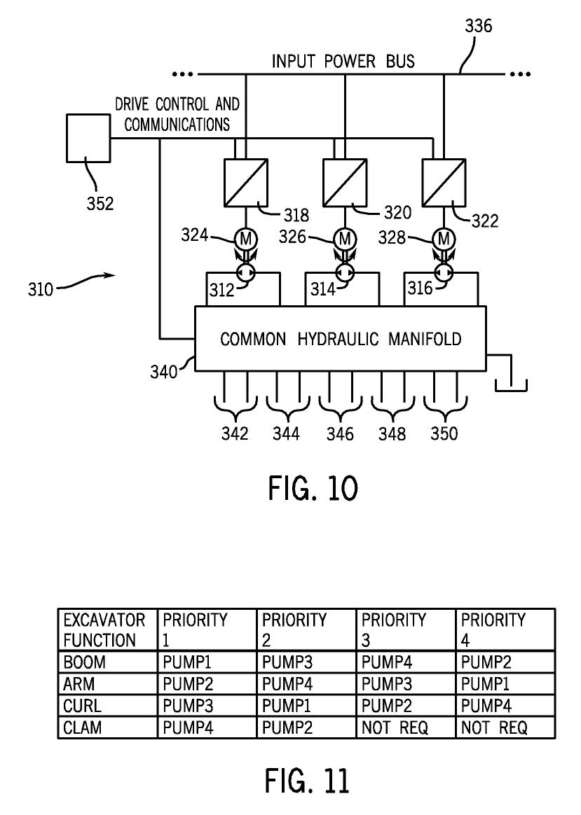

Referring to FIG. 10, a hydraulic system 310 for an excavator includes first, second, and third hydraulic pumps 312, 314, 316, which each include a variable speed drive 318, 320, 322, a motor 324, 326, 328 operated by the drive 318, 320, 322, and a fixed-displacement pumping mechanism 312, 314, 316 (e.g., piston set). The drives 318, 320, 322 receive power from an input power bus 336 (e.g., direct current bus), and the hydraulic pumps 312, 314, 316 are coupled to a common hydraulic manifold 340, which includes valving for distributing hydraulic fluid provided to the manifold 340 by the pumps 312, 314, 316. First, second, third, fourth, and fifth actuators 342, 344, 346, 348, 350 are coupled to the common hydraulic manifold 340, and receive hydraulic fluid from the manifold 340 to perform work functions of the excavator. The hydraulic system 310 further includes a supervisory controller 352 (e.g., computerized controller) in communication with the drives 318, 320, 322 of the hydraulic pumps 312, 314, 316 and the common hydraulic manifold 340. In contemplated embodiments, the common hydraulic manifold 340 may direct hydraulic fluid to the pumps 312, 314, 316, functioning as hydraulic motors, which drive the motors 324, 326, 328, functioning as electric generators for energy regeneration purposes.

In contemplated scenarios, all of the hydraulic pumps 312, 314, 316 may be operating at full capacity or a desired capacity (e.g., most fuel-efficient speed), where the output of the pumps 312, 314, 316 is insufficient to fully meet demands to facilitate all on-going work functions of the excavator. In such scenarios, the supervisory controller 352 uses a logic module to allocate, via control of the valving in the common hydraulic manifold 340, the available hydraulic fluid (e.g., energy) to the actuators 342, 344, 346, 348, 350 based, at least in part, upon prioritization logic (e.g., a table, a program, a matrix, an algorithm, etc.) of the work functions performed by the excavator. In some embodiments, additional inputs, such as sensor data, human-to-machine interface commands, and other inputs, are used by the supervisory controller 352 to allocate and reallocate the available hydraulic fluid during operation of the excavator. The logic module may be stored on supervisory controller 352 or elsewhere. Operation of the excavator according to the logic module is intended to provided an optimal compromise between work functions occurring at the same time.

According to an exemplary embodiment, the prioritization logic is adaptable (e.g., changeable, updatable); and, in some embodiments, dynamically updates during operation of the excavator. For example, if sensors indicate to the supervisory controller 352 that power supplied to one of the actuators 342, 344, 346, 348, 350 facilitating a digging function is insufficient, the supervisory controller 352 may reallocate hydraulic fluid supplied to others of the actuators 342, 344, 346, 348, 350 performing other work functions, such as crowding the bucket (see, e.g., bucket 222 as shown in FIG. 7). Alternatively, if an operator of the excavator desires to simultaneously lower the boom and drive the excavator forward, the supervisory controller 352 may reallocate hydraulic fluid to the actuators 342, 344, 346, 348, 350 associated with either work function, depending upon the prioritization logic. The supervisory controller 352 may provide reduced speed to one of the actuators 342, 344, 346, 348, 350 in exchange for increased torque to another.

Referring to FIG. 11, a form of prioritization logic includes a priority table, represented in FIG. 11 as a matrix. The matrix includes excavator functions and resources (e.g., hydraulic pumps) to provide hydraulic flow to perform the excavator functions. In such an embodiment, the computerized controller uses the prioritization logic provided in the matrix to assign different hydraulic pumps to different excavator functions, with different orders of priority. In some embodiments, the order of priority is determined by which functions are most critical to a dig cycle, such as a typical dig cycle or an optimal dig cycle.

During operation of the excavator, each function may require more than one hydraulic pump, and the excavator may not have enough hydraulic pumps to perform each function at full capacity. As such, the prioritization logic allows the computerized controller to assign or reassign hydraulic pumps to new or additional functions based upon dynamic variables, such as operator commands and digging conditions. If one or more of the hydraulic pumps fail or are at a reduced capacity, the prioritization logic is dynamically updated by the computerized controller. As different hydraulic pumps become available or are further required to perform particular work functions, the prioritization logic will adapt to provide a current optimal allocation of the resources for operation of the excavator. The allocation may be optimal with respect to fuel efficiency, rate of production, minimization of wear of components, operator preference, safety, mission, and/or other qualitative objectives or quantitative factors.

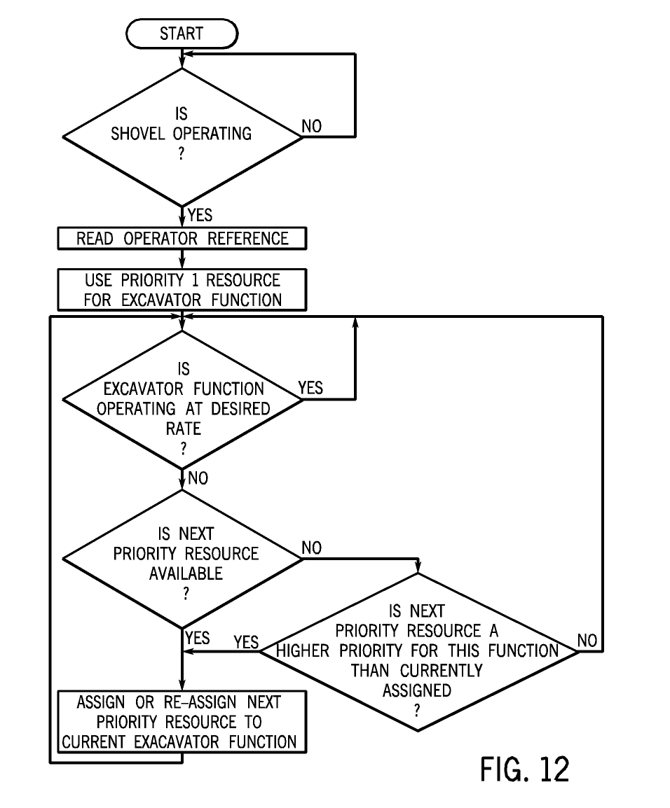

Referring now to FIG. 12, a logic flow diagram provides an exemplary application of the priority table. When the excavator is operating, the first priority resource is used to facilitate a first work function. If the first work function is not operating at a desired level, the logic module will use a second resource, if available, which corresponds to the next priority resource identified in the priority table. If the second resource is not available, the logic module determines whether the second resource has a higher priority a second work function, for which the second resource is currently assigned, or for the first work function. If the priority is higher for the first work function, then the second resource is reassigned to the first work function. Whether or not the addition of the second resource is sufficient to allow performance of the first work function at a desired level, the logic module returns to the step of determining whether the first work function is operating at the desired level, and the loop repeats with additional lower-priority resources being added as necessary to perform the first work function, and the remaining work functions in order of their priority. While FIG. 12 shows the logic flow diagram, in other contemplated embodiments, prioritization logic may be applied by the computerized controller according to a variety of logical algorithms, which may be more or less intricate than the logic flow of FIG. 12, and which may be specifically tailored to another arrangement of heavy equipment or hydraulic system.

The foregoing description was primarily directed to a preferred embodiment. Although some attention was given to various alternatives within the scope of the invention, it is anticipated that one skilled in the art will likely realize additional alternatives that are now apparent from disclosure of embodiments of the invention. Accordingly, the scope of the invention should be determined from the claims and not limited by the above disclosure.

The construction and arrangements of the heavy equipment and hydraulic systems, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. Heavy equipment, comprising:
a first hydraulic pump;
a second hydraulic pump;
a first hydraulic actuator facilitating a first work function of the heavy equipment;
a second hydraulic actuator facilitating a second work function of the heavy equipment;
valving configured to allow the first hydraulic pump to be coupled to the first hydraulic actuator and the second hydraulic actuator, and to allow the second hydraulic pump to be coupled to the first hydraulic actuator and the second hydraulic actuator; and
a computerized controller coupled to the valving, and having a logic module, wherein the logic module provides instructions to the computerized controller to operate the valving to distribute hydraulic fluid among the actuators as a function of inputs from an operator command, a sensor input, and prioritization logic associated with the first and second work functions, so as to optimize performance of the work functions facilitated by the hydraulic actuators with respect to available output of the hydraulic pumps.

2. The heavy equipment of claim 1, wherein the valving is configured to couple both the first and second hydraulic pumps to the same actuator of either the first or second actuators at the same time.

3. The heavy equipment of claim 2, wherein the prioritization logic comprises a priority table providing an order of priority for the first and second work functions.

4. The heavy equipment of claim 3, wherein the priority table is updated by the computerized controller during operation of the heavy equipment.

5. The heavy equipment of claim 4, further comprising:
a third hydraulic actuator, and
wherein the valving allows the first hydraulic pump to be coupled to any of the first, second, and third actuators, and allows the second hydraulic pump to be coupled to any of the first, second, and third actuators.

6. The heavy equipment of claim 5, further comprising:
a manifold, wherein the valving is associated with the manifold, and wherein the first and second hydraulic pumps deliver hydraulic fluid to the manifold and the first, second, and third hydraulic actuators receive hydraulic fluid from the manifold.

7. The heavy equipment of claim 6, wherein the computerized controller controls the speed of the first and second hydraulic pumps.

8. The heavy equipment of claim 7, wherein the first work function relates to moving a working implement of the heavy equipment, and the second work function relates to locomotion of the heavy equipment.

9. A hydraulic system, comprising:
a plurality of hydraulic pumps;
a plurality of hydraulic actuators facilitating work functions of the hydraulic system;
a manifold comprising a plurality of valves for controlling a flow of hydraulic fluid from the plurality of hydraulic pumps to the plurality of hydraulic actuators, wherein the plurality of valves of the manifold are configured to allow each of the plurality of hydraulic pumps to be coupled to any one of the plurality of hydraulic actuators while not being coupled to the others of the plurality of hydraulic actuators; and
a computerized controller coupled to the manifold, and having a logic module, wherein the logic module provides instructions to the computerized controller to operate the plurality of valves of the manifold to distribute hydraulic fluid flowing through the manifold among the plurality of actuators as a function of inputs from an operator command, a sensor input, and prioritization logic associated with the work functions, so as to optimize performance of the work functions facilitated by the plurality of hydraulic actuators with respect to available output of the plurality of hydraulic pumps.

10. The hydraulic system of claim 9, wherein the prioritization logic comprises a priority table providing an order of priority for the work functions.

11. The hydraulic system of claim 10, wherein the priority table is updated by the computerized controller during operation of the hydraulic system.

12. The hydraulic system of claim 11, wherein the plurality of valves of the manifold comprises solenoid valves.

13. The hydraulic system of claim 12, wherein the manifold includes a solenoid valve associated with a coupling between each hydraulic pump of the plurality of hydraulic pumps and each hydraulic actuator of the plurality of hydraulic actuators.

14. The hydraulic system of claim 13, wherein each hydraulic pump of the plurality of hydraulic pumps comprises an inverter, an electric motor, and pistons, and wherein the computerized controller operates the inverter.

15. Heavy equipment, comprising:
a body;
an articulated arm extending from the body;
a first actuator facilitating a first work function of the heavy equipment comprising raising and lowering the articulated arm;
a second actuator facilitating a second work function of the heavy equipment comprising moving the body of the heavy equipment;
a source of pressurized hydraulic fluid;
a manifold comprising a plurality of valves for distributing to the first and second actuators hydraulic fluid received from the source of pressurized hydraulic fluid; and
a computerized controller operating the manifold as a function of prioritization logic related to the first and second work functions, wherein the prioritization logic is updated by the computerized controller during operation of the heavy equipment.

16. The heavy equipment of claim 15, further comprising:
a first sensor associated with the first work function; and
a second sensor associated with the second work function,
wherein during operation of the heavy equipment the computerized controller updates the distribution of the hydraulic fluid from the manifold to the first and second actuators based upon feedback from the first and second sensors.

17. The heavy equipment of claim 16, wherein the prioritization logic comprises a priority table providing an order of priority for the first and second work functions.

18. The heavy equipment of claim 17, wherein the prioritization logic is updated in response to conditions external to the heavy equipment.

19. The heavy equipment of claim 18, further comprising an interface through which an operator provides inputs used by the computerized controller for operating the manifold.

20. The heavy equipment of claim 19, wherein the first actuator is a hydraulic cylinder facilitating movement of the articulated arm, and the second actuator is a hydraulic motor facilitating movement of the body.
